(19) United States
(12) Patent Application Publication
(10) Pub. No.: US 2022/0029377 A1
(43) Pub. Date: Jan. 27, 2022

(54) LASER DEVICE

(71) Applicant: SONY GROUP CORPORATION, TOKYO (JP)

(72) Inventor: GO HIRANO, TOKYO (JP)

(21) Appl. No.: 17/309,696

(22) PCT Filed: Oct. 29, 2019
(86) PCT No.: PCT/JP2019/042302

§ 371 Date: Jun. 15, 2021

(51) Int. Cl. H01S 3/11; H01S 3/06; H01S 3/16; H01S 3/08

(52) U.S. Cl. CPC H01S 3/1115; H01S 3/0623; H01S 3/08059; H01S 3/1643; H01S 3/1618

(57) ABSTRACT

Provided is a laser device capable of realizing the increased output and increased repeatability even when the surface roughness of the gain medium is large. The laser device includes: an excitation light source; a condensing optical system that condenses excitation light outputted from the excitation light source; a gain medium that receives the excitation light condensed by the condensing optical system and outputs emission light; a transparent member that has a smaller surface roughness than the gain medium and transmits the emission light outputted from the gain medium; a supersaturated absorber having a transmittance that increases as the emission light transmitted through the transparent member is absorbed; and a resonator that causes the emission light to resonate between the gain medium and the supersaturated absorber with the transparent member being interposed therebetween, wherein a dielectric multilayer film that reflects the excitation light and transmits the emission light is coated on the surface of the transparent member on the gain medium side.

### TECHNICAL FIELD

The technique according to the present disclosure (present technique) relates to a laser device.

### BACKGROUND ART

A microchip laser is a laser device including an excitation light source, a condensing optical system, a gain medium, a supersaturated absorber, and a resonator. The surface of the gain medium of the microchip laser on the supersaturated absorber side is coated with a dielectric multilayer film that reflects the excitation light and transmits the emission light of the gain medium. Since this dielectric multilayer film is located near the beam waist of the emission light that resonates in the resonator, the dielectric multilayer film is easily destroyed by the energy of the emission light.

It is generally known that a laser damage threshold of a coating film such as a dielectric multilayer film is affected by the surface state of the surface to be coated. It is reported in NPL 1 that the surface defect of the object to be coated causes an electric field enhancement and damages an antireflection film. NPL 2 reports that the laser damage threshold of the antireflection film changes depending on the surface roughness of the object to be coated.

As a means for improving the durability of a dielectric multilayer film, PTL 1 proposes a cooling structure using diamond in order to prevent thermal damage. However, where the surface roughness of the object to be coated is large, the electric field is enhanced, so that the durability of the dielectric multilayer film cannot be sufficiently improved only by preventing thermal damage.

### CITATION LIST

### Patent Literature

[PTL 1]
JP 1106-235806 A

### Non Patent Literature

[NPL 1]
N. Bloembergen: Appl. Opt. 22 (1973) 661.
[NPL 2]
Y. Nose et al.: Japan. J. Appl. Phys. 26 (1987) 1256.

### SUMMARY

### Technical Problem

In particular, when an yttrium aluminum garnet (ceramic YAG), which is a ceramic with small variation in characteristics, is used as the gain medium of a microchip laser, the surface accuracy of the ceramic YAG cannot be improved by polishing as compared with a single crystal YAG. For this reason, a dielectric multilayer film coated on the surface of the gain medium having a large surface roughness shows a remarkable decrease in durability. As a result, it becomes difficult to increase the output and repeatability.

The object of the present technique is to provide a laser device capable of realizing high output and high repeatability even when the surface roughness of the gain medium is large.

### Solution to Problem

A laser device according to one aspect of the present technique comprises: an excitation light source; a condensing optical system that condenses excitation light outputted from the excitation light source; a gain medium that receives the excitation light condensed by the condensing optical system and outputs emission light; a transparent member that has a smaller surface roughness than the gain medium and transmits the emission light outputted from the gain medium; a supersaturated absorber having a transmittance that increases as the emission light transmitted through the transparent member is absorbed; and a resonator that causes the emission light to resonate between the gain medium and the supersaturated absorber with the transparent member being interposed therebetween, wherein a first dielectric multilayer film that reflects the excitation light and transmits the emission light is coated on the surface of the transparent member on the gain medium side.

### BRIEF DESCRIPTION OF DRAWINGS

FIG. 1 is a schematic view showing an example of a laser device according to an embodiment of the present technique.

FIG. 2 is a partially enlarged view of the laser device shown in FIG. 1.

FIG. 3 is a schematic view of a laser device according to a comparative example.

FIG. 4 is a partially enlarged view of the laser device shown in FIG. 3.

FIG. 5 is a schematic view showing an example of a laser processing machine according to an embodiment of the present technique.

FIG. 6 is a schematic view showing an example of a laser device according to a first modification example of the embodiment of the present technique.

FIG. 7 is a schematic view showing an example of a laser device according to a second modification example of the embodiment of the present technique.

FIG. 8 is a partially enlarged view of the laser device shown in FIG. 7.

FIG. 9 is a partially enlarged view of a laser device according to a third modification example of the embodiment of the present technique.

FIG. 10 is a schematic view showing an example of a laser device according to a fourth modification example of the embodiment of the present technique.

FIG. 11 is a partially enlarged view of the laser device shown in FIG. 10.

### DESCRIPTION OF EMBODIMENTS

Hereinafter, embodiments of the present technique will be described with reference to the figures. In the description of the figures referred to in the following description, the same or similar parts are designated by the same or similar reference numerals. However, it should be noted that the figures are schematic, and the relationship between the thickness and the plane dimension, the ratio of the thickness of each layer, etc. are different from the actual ones. Therefore, the specific thickness and dimensions should be determined in consideration of the following explanation. In addition, it goes without saying that there are parts for which the dimensional relationship and the ratio are different among the figures.

The definition of directions such as up and down in the following description is merely for convenience of explanation, and does not limit the technical idea of the present technique. For example, where the object is rotated by 90° and observed, the top and bottom are read as converted to left and right, and where the object is rotated by 180° and observed, the top and bottom are read as reversed.

The effects described in the present specification are merely exemplary and are not limiting, and other effects may be obtained.

### <Configuration of Laser Device>

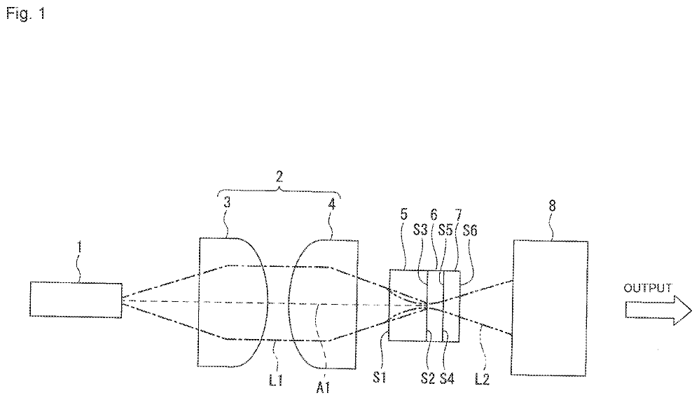

As shown in FIG. 1, the laser device according to the embodiment of the present technique is a microchip laser including an excitation light source 1, a condensing optical system 2, a gain medium 5, a transparent member 6, a supersaturated absorber 7, and a mirror (resonator mirror) 8.

The excitation light source 1 outputs excitation light L1. A semiconductor laser (laser diode) can be used as the excitation light source 1. The semiconductor laser may be an end face emitting laser or a vertical cavity surface emitting laser (VCSEL). In FIG. 1, the optical axis A1 of the excitation light L1 outputted by the excitation light source 1 is schematically shown by a broken line, and the excitation light L1 is shown by a dashed line.

The condensing optical system 2 condenses the excitation light L1 outputted from the excitation light source 1. The condensing optical system 2 includes a collimating lens 3 in which the excitation light L1 is converted into parallel light, and a condensing lens 4 that condenses the parallel excitation light L1 from the collimating lens 3.

The gain medium 5, the transparent member 6, and the supersaturated absorber 7 are arranged in order of description along the optical axis A1 of the excitation light L1. The gain medium 5, the transparent member 6, and the supersaturated absorber 7 are integrated by optical contact or joining. The transparent member 6 is adjacent to the gain medium 5 and is arranged in the direction of the surface S2 on the side opposite to the surface S1 of the gain medium 5 on the condensing optical system 2 side. The supersaturated absorber 7 is adjacent to the transparent member 6 and is arranged in the direction of the surface S4 on the side opposite to the surface S3 of the transparent member 6 on the gain medium 5 side. The resonator mirror 8 is arranged in the direction of the surface S6 on the side opposite to the surface S5 of the supersaturated absorber 7 on the transparent member 6 side.

The gain medium 5 receives the excitation light L1 condensed by the condensing optical system 2, amplifies the amplitude of the excitation light L1, and outputs the emission light L2. The thickness of the gain medium 5 along the optical axis A1 of the excitation light L1 is, for example, about 0.1 mm to 1 mm. The gain medium 5 includes a photoactive substance, and the photoactive substance is excited by the excitation light L1 to generate the emission light L2. The gain medium 5 is composed of, for example, a ceramic YAG. For example, a ceramic Yb:YAG in which ytterbium (Yb) is added to ceramic YAG at a concentration of about 10% to 50% is suitable as the gain medium 5. The excitation wavelength of the ceramic Yb:YAG is 940 nm, and the oscillation wavelength is 1030 nm. Hereinafter, a case where the ceramic Yb:YAG is used as the gain medium 5 will be described.

The transparent member 6 transmits the emission light L2 outputted from the gain medium 5. The thickness of the transparent member 6 along the optical axis A1 of the excitation light L1 is, for example, about 0.5 mm to 1 mm. As the transparent member 6, for example, quartz (SiO₂), sapphire, or diamond can be used. From the viewpoint of cooling the gain medium 5 at the time of optical contact or joining with the gain medium 5, a high thermal conductive material such as sapphire or diamond is preferable as the transparent member 6.

The transmittance of the supersaturated absorber 7 increases as the emission light L2 transmitted through the transparent member 6 is absorbed. That is, the supersaturated absorber 7 has a characteristic that the light absorption rate decreases due to the saturation of light absorption, and functions as a passive Q switch. The thickness of the supersaturated absorber 7 along the optical axis A1 of the excitation light L1 is, for example, about 0.5 mm to 1 mm. The initial transmittance of the supersaturated absorber 7 is, for example, about 30% to 95%. For example, ceramic Cr:YAG in which chromium (Cr) is added to ceramic YAG can be used as the supersaturated absorber 7.

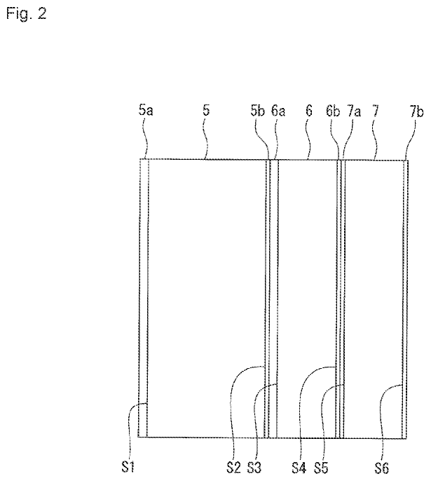

The resonator mirror 8 constitutes a resonator (8, 5a) together with a dielectric multilayer film 5a (see FIG. 2) coated on the surface S1 of the gain medium 5 on the condensing optical system 2 side. The resonator (8, 5a) causes the emission light L2 to resonate between the gain medium 5 and the supersaturated absorber 7 with the transparent member 6 being interposed therebetween. In FIG. 1, the resonating emission light L2 is schematically shown by a chain double-dashed line. The emission light L2 is amplified by the gain medium 5 while resonating in the resonator (8, 5a). A beam waist having a diameter of, for example, about 100 μm is formed near the surface S2 of the gain medium 5 on the transparent member 6 side, and the energy density is highest therein.

The resonator mirror 8 has a function of reflecting a part of the emission light L2 transmitted through the supersaturated absorber 7 and transmitting the rest of the emission light L2 transmitted through the supersaturated absorber 7. The emission light L2 transmitted through the resonator mirror 8 is outputted as pulsed laser light (oscillation light). The reflectance of the resonator mirror 8 with respect to the wavelength of the emission light L2 is, for example, about 30% to 95%. For example, a dielectric multilayer film can be used as the resonator mirror 8.

FIG. 2 shows an enlarged view of the portions of the gain medium 5, the transparent member 6, and the supersaturated absorber 7 shown in FIG. 1. The surface S1 of the gain medium 5 on the condensing optical system 2 side is coated with a dielectric multilayer film 5a constituting the resonator (8, 5a) together with the resonator mirror 8. The dielectric multilayer film 5a can be formed by alternately laminating dielectric layers made of materials having different refractive indexes, for example, such as SiO₂ and tantalum pentoxide (Ta₂O₅), or SiO₂ and hafnium oxide (HfO₂). The dielectric multilayer film 5a has a structure with the film thickness, the refractive index, and the number of film layers selected so that the dielectric multilayer film has a function of reflecting the emission light L2 outputted from the gain medium 5 and transmitting the excitation light L1. For example, the reflectance of the wavelength (1030 nm) of the emission light L2 is 99% or more, and the transmittance of the wavelength (940 nm) of the excitation light L1 is 95% or more. Meanwhile, the surface S2 of the gain medium 5 on the transparent member 6 side is coated with an antireflection film (AR coat) 5b that prevents reflection of the excitation light L1 and the emission light L2. The antireflection film (AR coat) 5b can be configured of a single layer or a plurality of layers of a dielectric film composed of a SiO₂ layer, Ta₂O₅ layer, and the like.

The surface S1 of the gain medium 5 on the condensing optical system 2 side and the surface S2 of the gain medium 5 on the transparent member 6 side are each polished before coating the dielectric multilayer film 5a and the antireflection film 5b, respectively. When a ceramic YAG is used as the gain medium 5, chemical polishing is difficult and only surface accuracy at a level of mechanical polishing can be obtained. For this reason, it is difficult to obtain surface accuracy and reduce surface roughness as compared with single crystal YAG, which is easy to chemically polish.

The surface S3 of the transparent member 6 on the gain medium 5 side is coated with a dielectric multilayer film 6a. The dielectric multilayer film 6a has a structure with the film thickness, the refractive index, and the number of film layers selected so that the dielectric multilayer film has a function of reflecting the excitation light L1 and transmitting the emission light L2. For example, the reflectance of the wavelength (940 nm) of the excitation light L1 is 99% or more, and the transmittance of the wavelength (1030 nm) of the emission light L2 is 95% or more. Meanwhile, the surface S4 of the transparent member 6 on the supersaturated absorber 7 side is coated with an antireflection film (AR coat) 6b that prevents reflection of the emission light L2. The antireflection film 6b can be configured of a single layer or a plurality of layers of a dielectric film composed of a SiO₂ layer, Ta₂O₅ layer, and the like.

The surface S3 of the transparent member 6 on the gain medium 5 side and the surface S4 of the transparent member 6 on the supersaturated absorber 7 side are each subjected to chemical polishing before coating the dielectric multilayer film 6a and the antireflection film 6b, respectively. Compared with the surface S1 of the gain medium 5 on the condensing optical system 2 side and the surface S2 of the gain medium 5 on the transparent member 6 side, surface accuracy can be easily obtained by chemical polishing, and surface roughness can be easily reduced. Therefore, the surface roughness of the surface S3 of the transparent member 6 on the gain medium 5 side and the surface S4 of the transparent member 6 on the supersaturated absorber 7 side is smaller than the surface roughness of the surface S1 of the gain medium 5 on the condensing optical system 2 side and the surface S2 of the gain medium 5 on the transparent member 6 side. For example, the calculated average roughness Ra of the surface S3 of the transparent member 6 on the gain medium 5 side and the surface S4 of the transparent member 6 on the supersaturated absorber 7 side may be about 0.1 nm to 1 nm.

The surface S5 of the supersaturated absorber 7 on the transparent member 6 side is coated with an antireflection film (AR coat) 7a that prevents reflection of the emission light L2. Meanwhile, the surface S6 of the supersaturated absorber 7 on the resonator mirror 8 side is coated with an antireflection film (AR coat) 7b that prevents reflection of the emission light L2. The antireflection films 7a and 7b can be configured of a single layer or a plurality of layers of a dielectric film composed of a SiO₂ layer, Ta₂O₅ layer, and the like.

It is preferable that the antireflection film 5b coated on the surface S2 of the gain medium 5 on the transparent member 6 side and the dielectric multilayer film 6a coated on the surface S3 of the transparent member 6 on the gain medium 5 side be in optical contact or joined by room temperature joining or the like. Further, it is preferable that the antireflection film 6b coated on the surface S4 of the transparent member 6 on the supersaturated absorber 7 side and the antireflection film 7a coated on the surface S5 of the supersaturated absorber 7 on the transparent member 6 side be in optical contact or joined by room temperature joining or the like.

### <Operation of Laser Device>

Next, the basic operation of the laser device according to the embodiment of the present technique will be described with reference to FIGS. 1 and 2. The excitation light L1 is outputted from the excitation light source 1 shown in FIG. 1, and the excitation light L1 is condensed by the condensing optical system 2. The excitation light L1 condensed by the condensing optical system 2 passes through the dielectric multilayer film 5a shown in FIG. 2 and is incident on the gain medium 5. The gain medium 5 receives the excitation light L1 and outputs the emission light L2. The emission light L2 outputted from the gain medium 5 passes through the antireflection film 5b, the dielectric multilayer film 6a, the transparent member 6, and the antireflection film 6b, and is incident on the supersaturated absorber 7. The emission light L2 transmitted by the supersaturated absorber 7 passes through the antireflection film 7b and reaches the resonator mirror 8. The emission light L2 is amplified by the gain medium 5 while resonating in the resonator (8, 5a).

When the light intensity of the emission light L2 outputted from the gain medium 5 is low, the laser oscillation does not occur because the light absorption rate of the supersaturated absorber 7 is high. Where the light intensity of the emission light L2 outputted from the gain medium 5 eventually increases and the light intensity in the supersaturated absorber 7 exceeds a predetermined value, the light absorption of the supersaturated absorber 7 is saturated and the light absorption rate suddenly decreases. Thus, as a result of the emission light L2 passing through the supersaturated absorber 7, induced emission occurs in the gain medium 5 and laser oscillation occurs. Where laser oscillation occurs, the light intensity of the emission light L2 outputted from the gain medium 5 decreases, and the light absorption rate of the supersaturated absorber 7 increases, so that the laser oscillation ends. In this way, the pulsed laser beam (oscillation light) is outputted from the laser device according to the embodiment of the present technique.

### Comparative Example

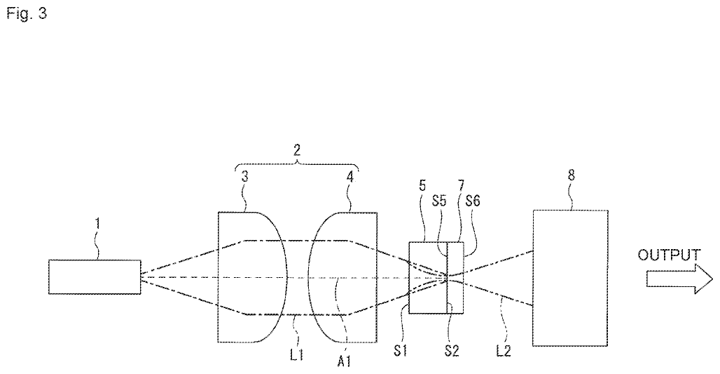

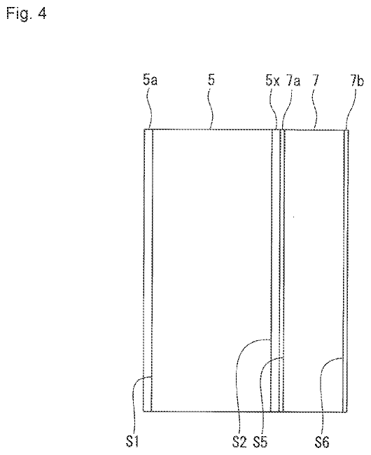

Here, the laser device according to a comparative example will be described with reference to FIGS. 3 and 4. As shown in FIG. 3, the laser device according to the comparative example differs from the laser device according to the embodiment of the present technique shown in FIG. 1 in that a transparent member is not arranged between the gain medium 5 and the supersaturated absorber 7.

FIG. 4 shows an enlarged view of the portion of the gain medium 5 and the supersaturated absorber 7 shown in FIG. 3. As in the laser device according to the embodiment of the present technique, the dielectric multilayer film 5a is coated on the surface S1 of the gain medium 5 on the condensing optical system 2 side. Meanwhile, the difference from the laser device according to the embodiment of the present technique is that a dielectric multilayer film 5x having a function of reflecting the excitation light L1 and transmitting the emission light L2 is coated on the surface S2 of the gain medium 5 on the supersaturated absorber 7 side.

As in the laser device according to the embodiment of the present technique, the antireflection film 7a that prevents reflection of the oscillation wavelength, is coated on the surface S5 of the supersaturated absorber 7 on the gain medium 5 side, and the antireflection film 7b that prevents reflection of the oscillation wavelength is coated on the surface S6 of the supersaturated absorber 7 on the resonator mirror 8 side.

The dielectric multilayer film 5x coated on the surface S2 of the gain medium 5 on the supersaturated absorber 7 side and the antireflection film 7a coated on the surface S3 of the supersaturated absorber 7 on the gain medium 5 side are in optical contact or joined by room temperature joining or the like.

In the laser device according to the comparative example, where the initial transmittance of the supersaturated absorber 7 is lowered to increase the output, and the power of the excitation light L1 is increased to increase the repeatability, the dielectric multilayer film 5x that is located near the beam waist and is on the surface S2 of the gain medium 5 on the transparent member 6 side is fractured by the energy of the emission light L2. That is, the durability of the dielectric multilayer film 5x is a constraint for increasing output and repeatability. In particular, when a ceramic YAG with little variation in characteristics is used as the gain medium 5 in anticipation of mass production, the breakdown of the dielectric multilayer film 5x becomes remarkable. This is because a ceramic YAG is more difficult to chemically polish than a single crystal YAG and it is difficult to reduce the surface roughness, so that only a dielectric multilayer film 5x having a low laser damage threshold can be coated. Further, the dielectric multilayer film 5x needs to have a large number of layers and a large film thickness so as to have a function of reflecting the excitation light L1 and transmitting the emission light L2, but the durability of the dielectric multilayer film 5x decreases as the number of layers and the film thickness increase.

### <Effect of the Embodiment of the Present Technique>

By contrast, in the laser device according to the embodiment of the present technique, the transparent member 6 is arranged between the gain medium 5 and the supersaturated absorber 7. Further, in the laser device according to the comparative example, the dielectric multilayer film 6a, which is similar to the dielectric multilayer film 5x coated on the surface S2 of the gain medium 5 on the supersaturated absorber 7 side and has a function of reflecting the excitation light L1 and transmitting the emission light L2, is coated on the surface S3 of the transparent member 6 on the gain medium 5 side that has a surface roughness smaller than that of the gain medium 5. Meanwhile, the antireflection film 5b, which is thinner and has fewer layers than the dielectric multilayer film 6a and prevents the reflection of the excitation light L1 and the emission light L2, is coated on the surface S2 of the gain medium 5 on the transparent member 6 side that has a surface roughness larger than that of the transparent member 6. In addition, the antireflection film 5b coated on the surface S2 of the gain medium 5 on the transparent member 6 side and the dielectric multilayer film 6a coated on the surface S3 of the transparent member 6 on the gain medium 5 side are optically contacted or joined.

Therefore, with the laser device according to the embodiment of the present technique, the dielectric multilayer film 6a is arranged at substantially the same position as the dielectric multilayer film 5x of the laser device according to the comparative example, but since the dielectric multilayer film 6a is coated on the transparent member 6 having a surface roughness smaller than that of the gain medium 5, it is possible to prevent the laser damage threshold of the dielectric multilayer film 6a from decreasing, and the durability of the dielectric multilayer film 6a can be improved. Meanwhile, the antireflection film 5b coated on the surface S2 of the gain medium 5 on the transparent member 6 side that has a surface roughness larger than that of the transparent member 6 is thinner and has fewer film layers than the dielectric multilayer film 6a, and therefore is less likely to be fractured when coated on the gain medium 5. Thus, even when ceramic YAG or the like having a large surface roughness is used for the gain medium 5, high output and high repeatability can be realized. Further, with the laser device according to the embodiment of the present technique, since no effect is produced by the surface roughness of the gain medium 5 such as ceramic YAG, quality is stabilized.

### <Laser Processing Machine>

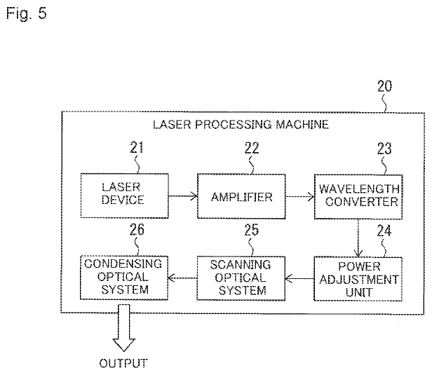

The laser device according to the embodiment of the present technique can be applied to a laser processing machine. For example, as shown in FIG. 5, a laser processing machine 20 according to the embodiment of the present technique includes a laser device 21, an optical amplifier (amplifier) 22, a wavelength converter 23, a power adjustment unit 24, a scanning optical system 25, and a condensing optical system (second condensing optical system) 26.

The laser device 21 has the configuration shown in FIGS. 1 and 2. That is, the laser device 21 includes the excitation light source 1, the condensing optical system (first condensing optical system) 2 that condenses the excitation light L1 outputted from the excitation light source 1, the gain medium 5 that is composed of a ceramic YAG and the like, receives the excitation light L1 condensed by the first condensing optical system 2, and outputs the emission light L2, the transparent member 6 that has a surface roughness smaller than that of the gain medium 5 and transmits the emission light L2 outputted from the gain medium 5, the supersaturated absorber 7 having a transmittance that increases as the emission light L2 transmitted through the transparent member 6 is absorbed, and the resonator (8, 5a) that causes the emission light L2 to resonate between the gain medium 5 and the supersaturated absorber 7 with the transparent member 6 being interposed therebetween. Further, the dielectric multilayer film 6a that reflects the excitation light L1 and transmits the emission light L2 is coated on the surface S3 of the transparent member 6 on the gain medium 5 side.

The amplifier 22 shown in FIG. 5 amplifies the laser light outputted from the laser device 21. The wavelength converter 23 converts the wavelength of the laser beam amplified by the amplifier 22. The wavelength converter 23 has a configuration for, for example, second harmonic generation (SHG), third harmonic generation (THG), fourth harmonic generation (FHG), and the like. The power adjustment unit 24 adjusts the power of the laser beam having the wavelength converted by the wavelength converter 23. The power adjustment unit 24 can be configured of, for example, a variable attenuator (variable attenuator). The scanning optical system 25 scans the laser beam that has power adjusted by the power adjustment unit 24. The scanning optical system 25 can be composed of, for example, a galvano scanner, a microelectromechanical system (MEMS) mirror, or the like. The second condensing optical system 26 condenses the laser light scanned by the scanning optical system 25 and irradiates the object to be processed with the condensed laser light. The condensing optical system 2 can be configured of, for example, an FO lens and an objective lens.

### First Modification Example

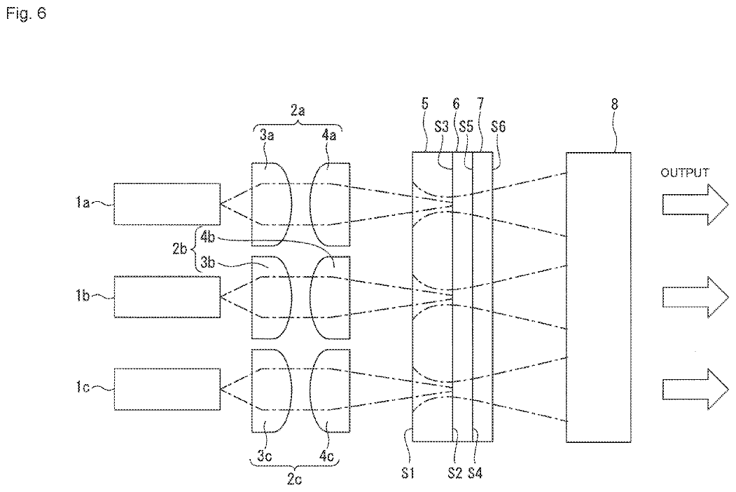

As shown in FIG. 6, the configurations of the laser device according to the first modification example of the embodiment of the present technique and the laser device according to the embodiment of the present technique differ in that the former is provided with a plurality of unit cells each corresponding to the laser device shown in FIG. 1. The laser device according to the first modification example of the embodiment of the present technique has a plurality of excitation light sources 1a, 1b, 1c and a plurality of condensing optical systems 2a, 2b, 2c. FIG. 6 illustrates a case where three unit cells corresponding to three excitation light sources 1a, 1b, 1c and three condensing optical systems 2a, 2b, 2c are arranged in one dimension, but the unit cells may be arranged in two dimensions. Further, the number of unit cells is not limited, and two unit cells may be arranged, or four or more unit cells may be arranged.

The condensing optical system 2a is arranged correspondingly to the excitation light source 1a, and includes a collimating lens 3a and a condensing lens 4a. The condensing optical system 2b is arranged correspondingly to the excitation light source 1b, and includes a collimating lens 3b and a condensing lens 4b. The condensing optical system 2c is arranged correspondingly to the excitation light source 1c, and includes a collimating lens 3c and a condensing lens 4c.

The configurations of the laser device according to the first modification example of the embodiment of the present technique and the laser device according to the embodiment of the present technique differ in that in the former, the gain medium 5, the transparent member 6, the supersaturated absorber 7, and the resonator portion of mirror (resonator mirror) 8 have an array structure. The supersaturated absorber 7 and the resonator mirror 8 may be integrated with each other with a spacer made of a transparent material interposed therebetween.

Although not shown in FIG. 6, a dielectric multilayer film that reflects emission light and transmits excitation light is coated on the surface S1 of the gain medium 5 on the condensing optical system 2 side. Meanwhile, an antireflection film (AR coat) that prevents reflection of excitation light and emission light is coated on the surface S2 of the gain medium 5 on the transparent member 6 side. The resonator is configured of a dielectric multilayer film coated on the surface S1 of the gain medium 5 on the condensing optical system 2 side and the resonator mirror 8.

Although not shown in FIG. 6, a dielectric multilayer film that reflects excitation light and transmits emission light is coated on the surface S3 of the transparent member 6 on the gain medium 5 side. Meanwhile, an antireflection film (AR coat) that prevents reflection of emission light is coated on the surface S4 of the transparent member 6 on the supersaturated absorber 7 side. An antireflection film (AR coat) that prevents reflection of emission light is coated on the surface S5 of the supersaturated absorber 7 on the transparent member 6 side. Meanwhile, an antireflection film (AR coat) that prevents reflection of emission light is coated on the surface S6 of the supersaturated absorber 7 on the resonator mirror 8 side.

The antireflection film coated on the surface S4 of the transparent member 6 on the supersaturated absorber 7 side and the antireflection film coated on the surface S5 of the supersaturated absorber 7 on the transparent member 6 side are preferably in optical contact or joined by room temperature joining or the like. The antireflection film coated on the surface S2 of the gain medium 5 on the transparent member 6 side and the dielectric multilayer film coated on the surface S3 of the transparent member 6 on the gain medium 5 side are preferably in optical contact or joined by room temperature joining or the like.

The gain medium 5 receives the excitation light (shown by a dot-dash line) converged by the converging optical systems 2a, 2b, and 2c, and outputs the emission light (shown by a two-dot-dash line). The emission light outputted from the gain medium 5 is amplified by the gain medium 5 while resonating in the resonator configured of the resonator mirror 8 and the dielectric multilayer film coated on the surface S1 of the gain medium 5 on the condensing optical system 2 side, and a pulsed laser beam (oscillation light) is outputted for each unit cell.

With the laser device according to the first modification example of the embodiment of the present technique, even in the case of having a plurality of unit cells which has a plurality of excitation light sources 1a, 1b, 1c and a plurality of condensing optical systems 2a, 2b, 2c and in which the gain medium 5, the transparent member 6, the supersaturated absorber 7, and the resonator portion of mirror (resonator mirror) 8 have an array structure, high output and high repeatability can be realized as in the laser device according to the embodiment of the present technique.

### Second Modification Example

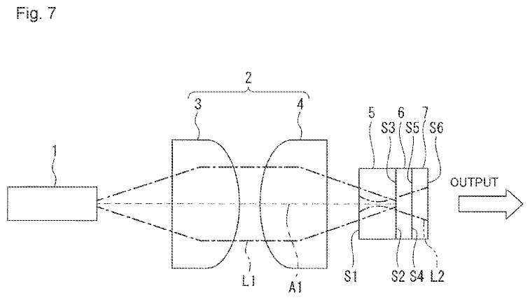

As shown in FIG. 7, the configuration of the laser device according to the second modification example of the embodiment of the present technique includes the excitation light source 1, the condensing optical system 2, the gain medium 5, the transparent member 6, and the supersaturated absorber 7 as the configuration of the laser device according to the embodiment of the present technique that is shown in FIG. 1. However, as shown in FIG. 7, the configurations of the laser device according to the second modification example of the embodiment of the present technique and the laser device according to the embodiment of the present technique that is shown in FIG. 1 differ in that in the former, a resonator mirror is not arranged on the surface S6 side of the supersaturated absorber 7 that is opposite to the surface S5 on the transparent member 6 side.

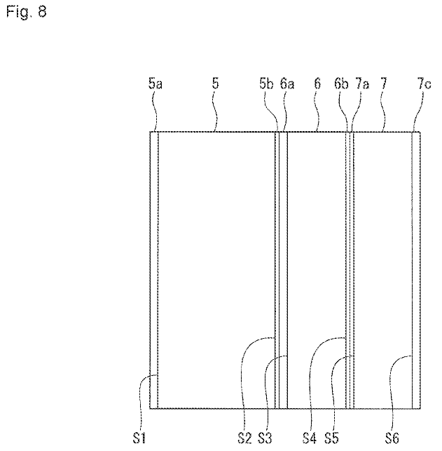

An enlarged view of the gain medium 5, the transparent member 6, and the supersaturated absorber 7 shown in FIG. 7 is shown in FIG. 8. Instead of the antireflection film 7b, a dielectric multilayer film (partial reflective mirror) 7c having the same reflectance as the resonator mirror 8 shown in FIG. 1 is coated on the surface S6 of the supersaturated absorber 7 that is opposite to the surface S5 on the transparent member 6 side. The dielectric multilayer film 7c has a function of reflecting a part of the emission light L2 transmitted through the supersaturated absorber 7 and transmitting the rest of the emission light L2 transmitted through the supersaturated absorber 7. That is, the dielectric multilayer film 7c constitutes a resonator (5a, 7c) together with the dielectric multilayer film 5a coated on the surface S1 of the gain medium 5 on the condensing optical system 2 side. The emission light L2 transmitted through the dielectric multilayer film 7c is outputted as pulsed laser light (oscillation light).

With the laser device according to the second modification example of the embodiment of the present technique, high output and high repeatability can be realized as in the laser device according to the embodiment of the present technique also in the case where instead of arranging the resonator mirror 8 individually as in the laser device according to the embodiment of the present technique shown in FIG. 1, the same role as that of the resonator mirror 8 is imparted to the dielectric multilayer film 7c coated on the surface S6 of the supersaturated absorber 7. In the laser device according to the first modification example of the embodiment of the present technique shown in FIG. 6, a dielectric multilayer film (partially reflective mirror) having the same reflectance as the resonator mirror 8 may also be coated on the surface S6 of the supersaturated absorber 7 without arranging the resonator mirror 8 individually in the same manner as in the laser device according to the second modification example of the embodiment of the present technique.

### Third Modification Example

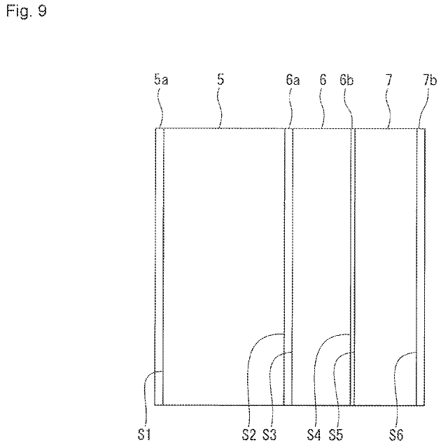

The overall configuration of the laser device according to the third modification example of the embodiment of the present technique is the same as the configuration of the laser device according to the embodiment of the present technique shown in FIG. 1. FIG. 9 shows an enlarged view of a portion of the gain medium 5, the transparent member 6, and the supersaturated absorber 7 of the laser device according to the third modification example of the embodiment of the present technique. In the case of a structure in which the gain medium 5, the transparent member 6, and the supersaturated absorber 7 are in optical contact or joined with each other as shown in FIG. 9, the antireflection film for preventing the reflection of the excitation light L1 and emission light L2 may not be coated on the surface S2 of the gain medium 5 on the transparent member 6 side. The surface S2 of the gain medium 5 on the transparent member 6 side may be optically contacted or joined to the dielectric multilayer film 6a that is coated on the surface S3 of the transparent member 6 on the gain medium 5 side and that reflects the excitation light L1 and transmits the emission light L2.

Further, the antireflection film that prevents reflection of the emission light L2 may not be coated on the surface S5 of the supersaturated absorber 7 on the transparent member 6 side. The surface S5 of the supersaturated absorber 7 on the transparent member 6 side may be optically contacted or joined to the antireflection film 6b that is coated on the surface S4 of the transparent member 6 on the supersaturated absorber 7 side and prevents reflection of the emission light L2.

Although not shown, an antireflection film that prevents reflection of the emission light L2 may be coated on the surface S5 of the supersaturated absorber 7 on the transparent member 6 side without coating the antireflection film 6b on the surface S4 of the transparent member 6 on the supersaturated absorber 7 side. In that case, the surface S4 of the transparent member 6 on the supersaturated absorber 7 side may be optically contacted or joined to the antireflection film coated on the surface S5 of the supersaturated absorber 7 on the transparent member 6 side.

With the laser device according to the third modification example of the embodiment of the present technique, in the case where the gain medium 5, the transparent member 6, and the supersaturated absorber 7 are in optical contact or joined to each other, the antireflection film may not be coated on, for example, the surface S2 of the gain medium 5 on the transparent member 6 side and the surface S5 of the supersaturated absorber 7 on the transparent member 6 side, respectively. In this case, high output and high repeatability can be also realized as in the laser device according to the embodiment of the present technique. In the laser device according to the third modification example of the embodiment of the present technique, a dielectric multilayer film (partially reflective mirror) having the same reflectance as the resonator mirror 8 may also be coated on the surface S6 of the supersaturated absorber 7 without arranging the resonator mirror 8 individually in the same manner as in the laser device according to the second modification example of the embodiment of the present technique.

### Fourth Modification Example

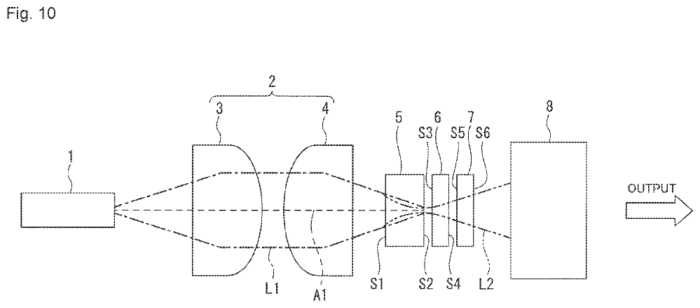

As shown in FIG. 10, the configuration of the laser device according to the fourth modification example of the embodiment of the present technique includes the excitation light source 1, the condensing optical system 2, the gain medium 5, the transparent member 6, the supersaturated absorber 7, and the resonator mirror 8 as the configuration of the laser device according to the embodiment of the present technique that is shown in FIG. 1. However, as shown in FIG. 10, the configurations of the laser device according to the fourth modification example of the embodiment of the present technique and the laser device according to the embodiment of the present technique that is shown in FIG. 1 differ in that in the former, the gain medium 5, the transparent member 6, and the supersaturated absorber 7 are separated from each other without optical contact or joining, and air gaps are formed between the gain medium 5 and the transparent member 6 and between the transparent member 6 and the supersaturated absorber 7, respectively.

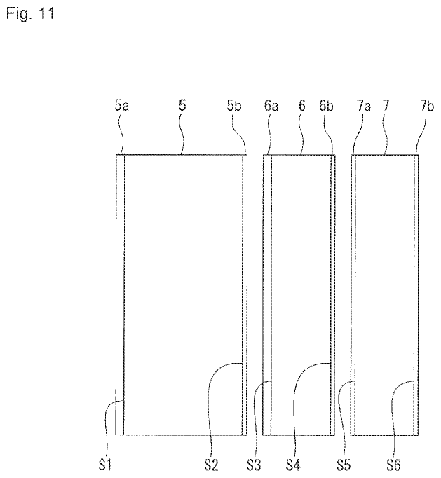

An enlarged view of the portion of the gain medium 5, the transparent member 6, and the supersaturated absorber 7 shown in FIG. 10 is shown in FIG. 11. As shown in FIG. 11, an air gap is formed between the antireflection film 5b coated on the surface S2 of the gain medium 5 on the transparent member 6 side and the dielectric multilayer film 6a coated on the surface S3 of the transparent member 6 on the gain medium 5 side. An air gap is also formed between the antireflection film 6b coated on the surface S4 of the transparent member 6 on the supersaturated absorber 7 side and the antireflection film 7a coated on the surface S5 of the supersaturated absorber 7 on the transparent member 6 side.

With the laser device according to the fourth modification example of the embodiment of the present technique, in the case where the gain medium 5, the transparent member 6, and the supersaturated absorber 7 are separated from each other, high output and high repeatability can be also realized as in the laser device according to the embodiment of the present technique. In the laser device according to the fourth modification example of the embodiment of the present technique, a dielectric multilayer film (partially reflective mirror) having the same reflectance as the resonator mirror 8 may also be coated on the surface S6 of the supersaturated absorber 7 without arranging the resonator mirror 8 individually in the same manner as in the laser device according to the second modification example of the embodiment of the present technique.

In the laser device according to the fourth modification example of the embodiment of the present technique, an air gap may be formed between the gain medium 5 and the transparent member 6, and the transparent member 6 and the supersaturated absorber 7 may be optically contacted or joined. Further, an air gap may be formed between the transparent member 6 and the supersaturated absorber 7, and the gain medium 5 and the transparent member 6 may be optically contacted or joined.

### Other Embodiments

The present technique has been described hereinabove by the embodiments, but the descriptions and figures that form part of the present disclosure should not be understood to limit the present technique. Various alternative embodiments, examples and operational techniques will be apparent to a person skilled in the art from the present disclosure.

For example, in the embodiments of the present technique, the case where the ceramic Yb:YAG is used for the gain medium 5 is illustrated, but another ceramic YAG may be used. For example, a ceramic Nd:YAG or the like in which neodymium (Nd) is added to a ceramic YAG may be used as the gain medium 5. The excitation wavelength of the ceramic Nd:YAG is 808 nm, and the oscillation wavelength is 1064 nm.

Further, although the case where the laser device according to the embodiment of the present technique applied to a laser processing machine is illustrated, the laser device according to the embodiment of the present technique can be also applied to an in-vehicle sensor such as a lidar (LiDAR) and can also be applied to various uses.

Thus, understanding the gist of the technical contents disclosed in the above embodiments will make it clear to a person skilled in the art that various alternative embodiments, examples and operational techniques can be included in the present technique. In addition, it goes without saying that the present technique includes various embodiments which are not described herein, such as configurations obtained by arbitrarily applying the configurations described in the embodiments and modification examples. Therefore, the technical scope of the present technique is defined only by the invention-defining matters related to the claims and regarded as appropriate based on the illustrative explanation hereinabove.

The present technique can have the following configurations.

(1)

A laser device comprising:

an excitation light source;
a condensing optical system that condenses excitation light outputted from the excitation light source;
a gain medium that receives the excitation light condensed by the condensing optical system and outputs emission light;
a transparent member that has a smaller surface roughness than the gain medium and transmits the emission light outputted from the gain medium;
a supersaturated absorber having a transmittance that increases as the emission light transmitted through the transparent member is absorbed; and a resonator that causes the emission light to resonate between the gain medium and the supersaturated absorber with the transparent member being interposed therebetween, wherein
a first dielectric multilayer film that reflects the excitation light and transmits the emission light is coated on the surface of the transparent member on the gain medium side.
(2)

The laser device as described in (1) above, wherein the transparent member and the gain medium are optically contacted or joined.

(3)

The laser device as described in (1) above, wherein an air gap is formed between the transparent member and the gain medium.

(4)

The laser device as described in any one of (1) to (3) above, wherein the surface of the gain medium on the transparent member side is coated with an antireflection film against the excitation light and the emission light.

(5)

The laser device as described in any one of (1) to (4) above, wherein the surface of the transparent member on the supersaturated absorber side is coated with an antireflection film against the emission light.

(6)

The laser device as described in any one of (1) to (5) above, wherein the transparent member and the supersaturated absorber are in optical contact or joined.

(7)

The laser device as described in any one of (1) to (5) above, wherein an air gap is formed between the transparent member and the supersaturated absorber.

(8)

The laser device as described in any one of (1) to (7) above, wherein the surface of the supersaturated absorber on the transparent member side is coated with an antireflection film against the emission light.

(9)

The laser device as described in any one of (1) to (8) above, wherein the gain medium is composed of a ceramic YAG.

(10)

The laser device as described in (9) above, wherein the ceramic YAG is ceramic YAG to which ytterbium is added.

(11)

The laser device as described in any one of (1) to (10) above, wherein the transparent member is silicon dioxide, sapphire or diamond.

(12)

The laser device as described in any one of (1) to (11) above, wherein the resonator comprises

a mirror that reflects a part of the emission light outputted from the supersaturated absorber and transmits the rest of the emission light; and
a second dielectric multilayer film coated on the surface of the gain medium on the condensing optical system side.
(13)

The laser device as described in (12) above, wherein the mirror is provided at a distance from the supersaturated absorber.

(14)

The laser device as described in (12) above, wherein the mirror is configured of a third dielectric multilayer film coated on a surface of the supersaturated absorber opposite to the surface on the transparent member side.

(15)

The laser device as described in any one of (1) to (4) that has a plurality of the excitation light sources and a plurality of the condensing optical systems, and the gain medium, the transparent member, the supersaturated absorber, and the mirror have an array structure.

### REFERENCE SIGNS LIST

1 Excitation light source
2 Condensing optical system
3 Collimating lens
4 Condensing lens
5 Gain medium
5a, 5x, 6a, 7c Dielectric multilayer film
5b, 6b, 7a, 7b Antireflection film
6 Transparent member
7 Supersaturated absorber
8 Resonator mirror
20 Laser processing machine
21 Laser device
22 Amplifier
23 Wavelength converter
24 Power adjustment unit
25 Scanning optical system

1. A laser device comprising:
an excitation light source;
a condensing optical system that condenses excitation light outputted from the excitation light source;
a gain medium that receives the excitation light condensed by the condensing optical system and outputs emission light;
a transparent member that has a smaller surface roughness than the gain medium and transmits the emission light outputted from the gain medium;
a supersaturated absorber having a transmittance that increases as the emission light transmitted through the transparent member is absorbed; and
a resonator that causes the emission light to resonate between the gain medium and the supersaturated absorber with the transparent member being interposed therebetween, wherein
a first dielectric multilayer film that reflects the excitation light and transmits the emission light is coated on the surface of the transparent member on the gain medium side.

2. The laser device according to claim 1, wherein the transparent member and the gain medium are optically contacted or joined.

3. The laser device according to claim 1, wherein an air gap is formed between the transparent member and the gain medium.

4. The laser device according to claim 1, wherein the surface of the gain medium on the transparent member side is coated with an antireflection film against the excitation light and the emission light.

5. The laser device according to claim 1, wherein the surface of the transparent member on the supersaturated absorber side is coated with an antireflection film against the emission light.

6. The laser device according to claim 1, wherein the transparent member and the supersaturated absorber are in optical contact or joined.

7. The laser device according to claim 1, wherein an air gap is formed between the transparent member and the supersaturated absorber.

8. The laser device according to claim 1, wherein the surface of the supersaturated absorber on the transparent member side is coated with an antireflection film against the emission light.

9. The laser device according to claim 1, wherein the gain medium is composed of a ceramic YAG.

10. The laser device according to claim 9, wherein the ceramic YAG is ceramic YAG to which ytterbium is added.

11. The laser device according to claim 1, wherein the transparent member is silicon dioxide, sapphire or diamond.

12. The laser device according to claim 1, wherein
the resonator comprises
a mirror that reflects a part of the emission light outputted from the supersaturated absorber and transmits the rest of the emission light; and
a second dielectric multilayer film coated on the surface of the gain medium on the condensing optical system side.

13. The laser device according to claim 12, wherein the mirror is provided at a distance from the supersaturated absorber.

14. The laser device according to claim 12, wherein the mirror is configured of a third dielectric multilayer film coated on a surface of the supersaturated absorber opposite to the surface on the transparent member side.

15. The laser device according to claim 1 that has a plurality of the excitation light sources and a plurality of the condensing optical systems, and the gain medium, the transparent member, the supersaturated absorber, and the mirror have an array structure.
